(19) United States
(12) Patent Application Publication
(10) Pub. No.: US 2009/0073179 A1
(43) Pub. Date: Mar. 19, 2009

(54) ADDRESSING ON CHIP MEMORY FOR BLOCK OPERATIONS

(75) Inventors: Tomson George, Kerala (IN); Bijo Thomas, Kerala (IN); Ranjith Gopalakrishan, Bangalore (IN)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 12/281,982

(22) PCT Filed: Mar. 5, 2007
(86) PCT No.: PCT/IB07/50718

§ 371 Date: Sep. 6, 2008

(30) Foreign Application Priority Data
Mar. 6, 2006 (EP) 06110716.5
Mar. 5, 2007 (IB) PCT/IB2007/050718

(51) Int. Cl. G09G 5/399

(52) U.S. Cl. 345/564

(57) ABSTRACT

A method for circularly accessing a plurality of memory addresses, using a sequence of values comprises determining a plurality of values, the number of values in the plurality of values being m, each value being represented by a predefined number of bits n. The method further comprises identifying in a register (20) of a processor, comprising a plurality of addressable bits ordered by significance, a sequence of m times n consecutive bits, thus having defined a set of m units (21, 22, 23, 24) of n consecutive bits each. It involves initializing each unit of the set of units with the bits representing a different value of the plurality of values, and rotating the identified bits of the register (20) with a number of bits equal to an integer multiple of n. The method also comprises reading a unit for obtaining a value represented by the unit.

### FIELD OF THE INVENTION

The invention relates to a method for circularly accessing a plurality of memory addresses.

The invention also relates to a computer program product and to a system for circularly using a sequence of values.

### BACKGROUND OF THE INVENTION

Digital signal processing in general and image processing in particular frequently involves executing block type operations. The block type operations may comprise performing a computation using a block of pixels, for example a block of 3×3 pixels or 5×5 pixels. These computations can be performed efficiently by loading a number of lines in respective memory buffers of a fast memory, the number of lines corresponding to the size of the block, and then performing the relevant computations on the blocks comprised in the loaded buffers. For example, in the case of 3×3 blocks, three consecutive lines of pixels may be loaded into the fast memory. Subsequently, the computations are done for the thus available blocks while simultaneously loading a fourth consecutive line into the fast memory. After having completed the computations for the first three consecutive lines, the first of those lines is discarded. The two remaining lines of pixels in combination with the fourth line again form three lines for performing block processing of 3×3 blocks. Addressing the lines of pixels in the fast memory is relatively computationally expensive. Four pointers to the beginning of the memory buffers corresponding to the successive lines of pixels are maintained, and after processing the blocks corresponding to the first three lines and after loading the fourth line of pixels into memory, the blocks corresponding to the second to fourth lines are processed and the fifth line is loaded in the memory buffer originally containing the pixels of the first line. This process is repeated until the complete image has been processed. An indexed table containing the pointers to the buffers is maintained, and indices are maintained indicating which line is in which buffer to be processed and indicating into which buffer the next line is to be loaded. After having processed the blocks and having loaded the next line, the indices are incremented modulo the number of pointers in the table, that is, the number of buffers, so that each pointer is used differently in a circular manner. Thus if the number of pointers is four, four modulo operations are required. However, modulo computation is a computationally expensive operation.

In U.S. Pat. No. 5,463,749, a simplified cyclical buffer is disclosed. The buffer has an integer number of memory locations M in respect of which a number of consecutive memory locations STEP are required to be accessed in a single operation and having a predetermined START location defining an initial memory location to be accessed. M is constrained to be an integer multiple of STEP and the k least significant bits of START are zero where k is the minimal integer satisfying the relation 2^{k}>M−|STEP|. The result is the same as the general modulo algorithm employed in conventional cyclical buffers but without the cost of implementing the complete modulo function. An apparatus for generating successive addresses involves an adder and a k-bit comparator coupled via a multiplexer to an address register such that the k least significant bits of the adder or M−|STEP| or 0 is fed to the k least significant bits of the address register depending on the output of the k-bit comparator. This is a relatively complex way of addressing a circular buffer.

### SUMMARY OF THE INVENTION

It is an object of the invention to provide a more efficient way of circularly accessing a plurality of memory addresses.

This object is realized by providing a method using a sequence of a plurality of m values wherein each value is represented by a predefined number of n bits, comprising
initializing a plurality of bits of a register (58) of a processor (51) with a bit sequence including a concatenation of the m bit representations of the respective m values; and
repeatedly
   rotating the plurality of bits of the register with a number of bits equal to an integer multiple of n;
   reading n predetermined bits of the register corresponding to one of the m bit representations to obtain one of the m respective values; and
   identifying a memory address based on the obtained value.

The method can include performing the steps of reading n predetermined bits of the register and identifying a memory address more than one time, reading n different predetermined bits each time, between successive rotations of the plurality of bits of the register. Hereinafter a unit shall indicate a sequence of n bits of the register representing one of the m values. A plurality of units can be read followed by the rotating, after which the plurality of units is read again. The integer multiple determines how fast the method steps through the plurality of values. If the integer multiple is equal to 1, the values are stepped through one by one. If the integer multiple is equal to or larger than 2, some values may be skipped. If the integer multiple is negative, the order of stepping through the values is opposite as compared to a positive integer multiple. If the integer multiple is 0, the same value is accessed each time.

An embodiment of the invention further comprises
identifying a table base address; and
reading or writing a memory at the identified memory address; wherein
the step of identifying the memory address is also performed in dependence on the table base address.

This embodiment is a particularly practical way to cycle through a number of values, stored at distinct memory addresses. This is advantageous when the values may be represented by more than n bits.

An embodiment of the invention further comprises
reading a pointer value at the identified memory address;
reading or writing the memory at an address based on the pointer value.

In this way, it is possible to cycle through pointers. Also, it is possible to cycle through blocks of data associated with the pointers.

In an embodiment of the invention, the steps of
obtaining a value represented by n predetermined bits of the register,
identifying a memory address,
reading a pointer value, and
reading or writing the memory
are performed a plurality of times for different predetermined bits of the register resulting in different respective read pointer values between two successive performances of the step of rotating the plurality of bits.

This embodiment makes it possible to apply different processing steps to different buffers in a cyclical manner. It also allows to perform a processing step on data in a first buffer while loading a second buffer with new data simultaneously.

In another embodiment, the step of obtaining a value represented by n predetermined bits of the register is performed for all m values, each value being represented by a respective n bits.

This aspect is advantageously used if the processing algorithm involves processing a plurality of buffers in a different way simultaneously, and the role of each buffer changes in a repetitive way between processing steps.

In another embodiment, the respective read pointer values are associated with respective memory buffers, and the method comprises processing data stored in a plurality of the respective memory buffers.

The processing can be performed more efficiently if the memory buffers are part of a fast memory or cache memory. In particular if a data set needs to be processed that is too large to be loaded in the fast memory completely, part of the data set can be loaded in the memory buffers for processing.

In another embodiment, the step of processing data comprises performing a block type operation on an at least two-dimensional image, each memory buffer being loaded with a line of the image, the loaded lines collectively comprising block-shaped subsets of the image, and the block type operation is performed on blocks of pixels of the image by reading corresponding pixel values from the memory buffers.

This allows a highly efficient cyclic use of the buffers.

In another embodiment of the invention, a computer program product comprises instructions for causing a processor to perform the method of claim 1.

The invention also relates to a system as defined in claim 9.

### BRIEF DESCRIPTION OF THE DRAWINGS

These and other aspects of the invention will be elucidated hereinafter in the description of the drawing, wherein

FIG. 1 is an illustration of how the invention can be applied to a block filtering operation;

FIG. 2 is an illustration of a data access pattern;

FIG. 3 is an illustration of a way of indexing memory addresses;

FIG. 4 illustrates cycling through the indices;

FIG. 5 is another illustration of cycling through the indices;

FIG. 6 is a system diagram of an embodiment of the invention.

### DETAILED DESCRIPTION OF THE INVENTION

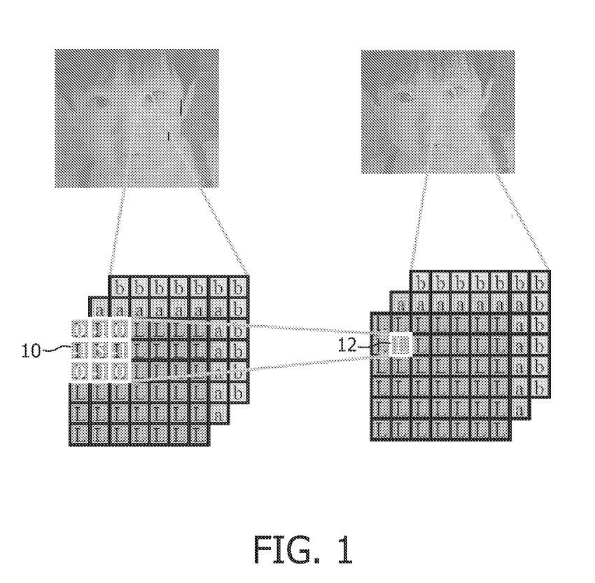

FIG. 1 illustrates a typical example application of the invention. Other applications of the invention will be apparent to the skilled artisan. In this example, a block filter is applied to an image. The filter of the example has a 3×3 kernel 10. Other kernel (also known as footprint) sizes are possible, such as for example a 3×10 kernel or 5×20 filter, or any M×N kernel. A step of the filter operation may comprise multiplying pixel values with kernel elements and summing the values resulting from the multiplications. The result is stored as a pixel 12 in the resulting filtered image. An efficient way of processing an image with such a filter kernel starts by loading three consecutive lines in a fast memory and repeatedly performing the steps of
performing the required operations with the three lines loaded in the fast memory,
loading the next consecutive line in the fast memory,
releasing the fast memory holding the first consecutive line.

Here, the steps of performing the required operations and loading the next line can be performed in parallel. To make the method more efficient, instead of releasing the fast memory holding the first consecutive line, this fast memory is reserved for loading the next consecutive line in the fast memory. This means that four memory buffers are allocated in the fast memory, each buffer capable of holding the pixel values of a single line of the image. Each line is kept in the buffer for three iterations for processing, after which the buffer is overwritten with a new line of the image. Each buffer can have four different roles in an iteration: the role of being multiplied with the first line of the kernel, the role of being multiplied with the second line of the kernel, the role of being multiplied with the third line of the kernel, and the role of being overwritten with the next consecutive line of the image. These roles are rotated over the four buffers after each iteration.

Similar scenarios are obvious to the skilled artisan, for example if a 5×5 kernel were used in the above example, 6 fast memory buffers could be used of which 5 would contain consecutive lines of the image and one would be overwritten with the next consecutive line.

The principle of reserving a buffer for loading new data while executing a filter on another buffer containing data is also referred to as double buffering.

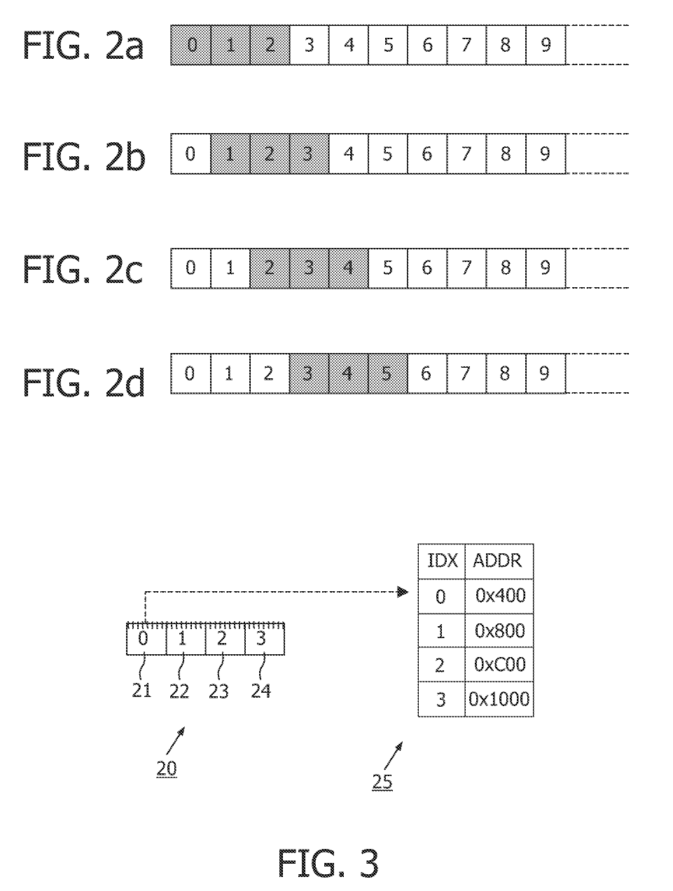

FIG. 2 illustrates the lines of the image that are used for the processing in each iteration in the example of FIG. 1. Three memory buffers are initialized with the pixel values of the first three respective image lines. In the first iteration a, lines 0, 1, and 2 are processed using the respective memory buffers holding their pixels and line 3 is copied into a fourth memory buffer. In the second iteration b, lines 1, 2, and 3 are processed and pixel values of line 4 are copied into the fast memory buffer originally containing line 0. In the third iteration c line 5 is loaded into the fast memory buffer originally containing line 1, and so on.

FIG. 3 shows how a register 20 is divided into units 21, 22, 23, 24 according to the invention. Each buffer for storing a line of pixel data is associated with a memory address. An index IDX is associated with each address ADDR as shown in the table 25. The Figure also shows a register 20. The register is part of a processor, such as for example a digital signal processor (DSP) or a central processing unit (CPU). In the case of a processor using binary computations, the register comprises a number of bits, ordered by significance. A predetermined subsequence of consecutive bits (i.e., consecutive when ordered by significance) is called a unit hereinafter. In this example, four units (21, 22, 23, 24) are used each comprising eight bits (illustrated by small dashes), and the register comprises 32 bits in total. A register may comprise any number of bits, and often comprises more than 32 bits. The Figure is to be regarded as an example only. The bits of a unit represent an index value corresponding to the indices occurring in table 25. As an example, the eight most significant bits of the register 20 form a unit 21. All eight bits of the unit 21 are zero; therefore, the index value represented by the bits is zero. Looking up index value zero in the table results in finding the associated memory address 0x400. This can mean that the fast memory buffer associated with index value zero can be found at address 0x400. The three remaining units 22, 23, and 24 represent index values 1, 2, and 3, respectively as shown and are associated with the memory addresses 0x800, 0xC00, and 0x1000 as shown in the table 25.

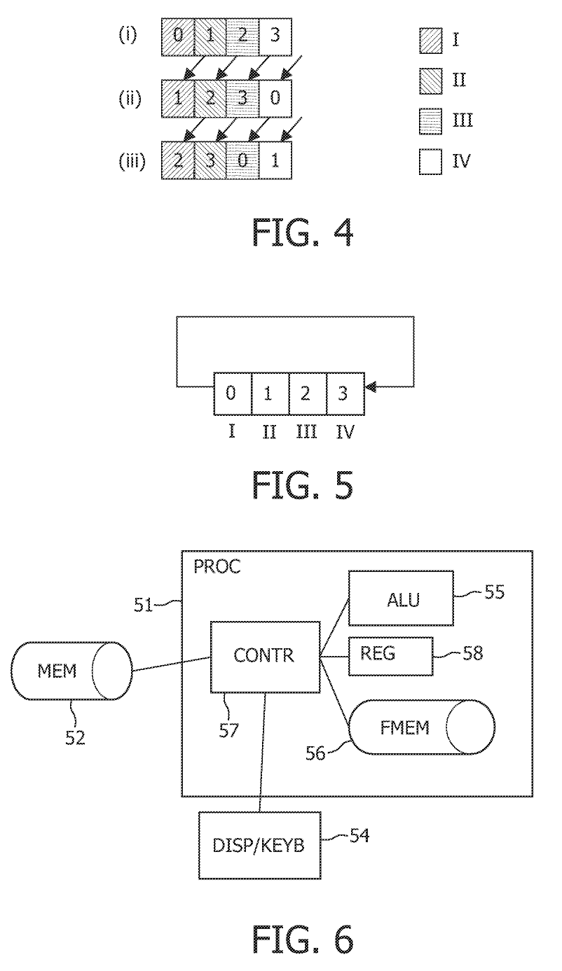

FIG. 4, associates four roles (I, II, III, and IV) with different line patterns as indicated. Each buffer can have different roles in each iteration, and typically the role of at least one buffer changes among a predetermined number of roles in a circular fashion. In our example four different roles are identified as follows. The first role (I) is the role of containing pixels of a line for multiplication with the first line of the kernel, the second role (II) is the role of containing pixels of a line for multiplication with the second line of the kernel, the third role (III) is the role of containing pixels of a line for multiplication with the third line of the kernel, and the fourth role (IV) is the role of being overwritten with the pixels of the next consecutive line of the image. These roles are rotated over the four buffers after each iteration. The buffers can be identified by means of index values. The Figure also shows the state of the register during several iterations of the block processing operation. In the first iteration (i), the index values 0, 1, 2, and 3 are associated with roles I, II, III, and IV, respectively, as shown. In the second iteration (ii), the index values 1, 2, 3, and 0 are associated with roles I, II, III, and IV, respectively, as shown. In the third iteration (iii), index values 2, 3, 0, and 1 are associated with roles I, II, III, and IV, respectively, as shown. Thus the roles rotate with respect to the index values. Each index value can be associated with a memory buffer as indicated in table 25, thus the roles rotate with respect to the buffers.

FIG. 5 contains another illustration of a number of values represented by units within a register. The different values represented by each unit can be used in a number of different ways, indicated I, II, III, IV in the Figure. By rotating the register by the number of bits in a unit, as shown by the circular arrow, the index values rotate. Since the way each unit is used is fixed (I, II, III, IV correspond to the same unit of the register), the way each value is used in each iteration also rotates circularly. Usually, the register is rotated by the number of bits of a unit. However, it is also possible to rotate by a multiple of the number of bits of a unit. This is particularly useful if one would like to advance the rotation with two steps between iterations.

FIG. 6 contains a simplified diagram of an embodiment of the invention. The Figure shows a processor 51, a display and/or keyboard 54, and memory 52. The processor can for example be a digital signal processor or a central processor unit. The processor 51 comprises control means 57, arithmetic and logic unit 55, register 58, and fast memory 56. For example, the fast memory can be on-chip cache memory. Alternatively, the fast memory can be implemented as a fast memory cache external to the processor (not shown). Access to the fast memory is relatively fast compared to access to the ‘normal’ memory 52. The configuration shown can be used to perform the method set forth. For example, an image is stored in memory 52. Four memory buffers are allocated in the fast memory 56 and a table 25 according to FIG. 3 containing the addresses of each buffer is stored in the fast memory 56. A 32-bit register 58 of the processor (also shown as register 20 of FIG. 3) is divided into four 8-bit units 21, 22, 23, 24 and each unit is initialized by the control means 57 with one of the indices of the table 25. The control means 57 copies the first three lines of the image from the memory 52 into the buffers in fast memory 56 associated with the addresses stored in the table at the indices represented by the first three units 21, 22, 23. After that, multiple iterations are performed as follows. The control unit 57 obtains from the register 58 a value represented by a predetermined unit. This could be implemented efficiently by a processor instruction allowing access to a particular byte of the register 58. The control means 57 looks up the memory address associated with the obtained index value in the table 25. This is performed for all required units. The arithmetic and logic unit 55 performs an image processing operation on the data stored in the buffers thus determined. Simultaneously or sequentially, the control means 57 copies the next line of the image from the memory 52 into the buffer in fast memory 56 associated with the address stored in the table at the index represented by the fourth unit 24. After that, the control means 57 rotates the register 58 by 8 bits, or in particular by the number of bits contained in a unit 21, and the next iteration starts. The iterations stop when all relevant lines of the image have been processed.

Many applications of the invention will be obvious to the person skilled in the art. In this description, the application of applying a two-dimensional block filter to an image has been discussed. However, the invention can be applied equally well to three-dimensional filters for filtering volumetric datasets. Volumetric data sets comprise voxels ordered in a three-dimensional grid. The filter correspondingly also has a kernel extending in three dimensions. Consider a three-dimensional filter kernel with size L×M×N. For efficient computation, a number of lines of voxel values is loaded in the buffers. In this case, L×M+L buffers could be used. L×M buffers could be used for multiplication with filter kernel values, and the remaining L buffers could be used for double buffering, as set forth. Volumetric datasets typically occur in medical imaging.

The invention can be used to advantage for any application which requires a circular reading of predetermined values; in particular, for any application which requires repeated reading of a sequence of values, wherein the repeated readings differ in that a value that appears first in the sequence at a reading of the sequence should appear last at the next reading of the sequence.

It will be appreciated that the invention also extends to computer programs, particularly computer programs on or in a carrier, adapted for putting the invention into practice. The program may be in the form of source code, object code, a code intermediate source and object code such as partially compiled form, or in any other form suitable for use in the implementation of the method according to the invention. The carrier may be any entity or device capable of carrying the program. For example, the carrier may include a storage medium, such as a ROM, for example a CD ROM or a semiconductor ROM, or a magnetic recording medium, for example a floppy disc or hard disk. Further the carrier may be a transmissible carrier such as an electrical or optical signal, which may be conveyed via electrical or optical cable or by radio or other means. When the program is embodied in such a signal, the carrier may be constituted by such cable or other device or means. Alternatively, the carrier may be an integrated circuit in which the program is embedded, the integrated circuit being adapted for performing, or for use in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A method for circularly accessing a plurality of memory addresses, using a sequence of a plurality of m values wherein each value is represented by a predefined number of n bits, comprising
initializing a plurality of bits of a register of a processor with a bit sequence including a concatenation of the m bit representations of the respective m values; and
repeatedly
rotating the plurality of bits of the register with a number of bits equal to an integer multiple of n;
reading n predetermined bits of the register corresponding to one of the m bit representations to obtain one of the m respective values; and
identifying a memory address based on the obtained value.

2. The method according to claim 1, further comprising
identifying a table base address; and
reading or writing a memory at the identified memory address; wherein
the step of identifying the memory address is also performed in dependence on the table base address.

3. The method of claim 2, further comprising
reading a pointer value at the identified memory address;
reading or writing the memory at an address based on the pointer value.

4. The method of claim 3, wherein the steps of
obtaining a value represented by n predetermined bits of the register,
identifying a memory address,
reading a pointer value, and
reading or writing the memory
are performed a plurality of times for different predetermined bits of the register resulting in different respective read pointer values between two successive performances of the step of rotating the plurality of bits.

5. The method of claim 4, wherein the step of obtaining a value represented by n predetermined bits of the register is performed for all m values, each value being represented by a respective n bits.

6. The method of claim 4, wherein the respective read pointer values are associated with respective memory buffers, and the method comprises processing data stored in a plurality of the respective memory buffers.

7. The method of claim 6, wherein the step of processing data comprises performing a block type operation on an at least two-dimensional image, each memory buffer being loaded with a line of the image, the loaded lines collectively comprising block-shaped subsets of the image, and the block type operation is performed on blocks of pixels of the image by reading corresponding pixel values from the memory buffers.

8. A computer program product comprising instructions for causing a processor to perform the method of claim 1.

9. A system for circularly accessing a plurality of memory addresses, using a sequence of a plurality of m values wherein each value is represented by a predefined number of n bits, comprising
means for initializing a plurality of bits of a register of a processor with a bit sequence including a concatenation of the m bit representations of the respective m values; and
means for repeatedly
rotating the plurality of bits of the register with a number of bits equal to an integer multiple of n;
means for reading n predetermined bits of the register corresponding to one of the m bit representations to obtain one of the m respective values; and
means for identifying a memory address based on the obtained value.
